(19) United States
(12) Patent Application Publication
(10) Pub. No.: US 2017/0356641 A1
(43) Pub. Date: Dec. 14, 2017

(54) ARTIFICIAL BIRTHDAY CAKE CANDLE HOLDER

(71) Applicant: Gordon Leo Hintz, Lompoc, CA (US)

(72) Inventor: Gordon Leo Hintz, Lompoc, CA (US)

(21) Appl. No.: 15/382,651

(22) Filed: Dec. 17, 2016

Related U.S. Application Data
(60) Provisional application No. 62/348,324, filed on Jun. 10, 2016.

(51) Int. Cl. F21V 35/00; F21W 121/00

(52) U.S. Cl. CPC F21V 35/00; F21W 2121/002

(57) ABSTRACT

A monolithic base having a plurality of holes with bottoms provide a place for burning birthday candles independent of a real cake as an independent birthday candle holder. All the burning candles are in a plane. Simulating a birthday cake avoids some of the problems associated with placing the candles on a real cake. Accommodation for as many as one hundred candles may be provided. Three exemplary embodiments employ solids such as wood, ceramics, clay, plaster or plastics.

### REFERENCE TO RELATED APPLICATIONS

This application claims the priority of U.S. provisional application Ser. No. 62/348,324 filed on Jun. 10, 2016 entitled ARTIFICIAL BIRTHDAY CAKE CANDLE HOLDER, the disclosure of which is incorporated herein by reference.

### BACKGROUND

### Field

This invention relates generally to decorations for birthday celebrations and more particularly to a candle holder shaped in the appearance of a birthday cake and having a plurality of holes adapted to receive and support birthday candles.

### Description of the Related Art

It is a common practice for people to celebrate birthdays. Central to most celebrations is the birthday cake with candles. But each birthday celebration is not a duplication of the last one. Sometimes people celebrate without a cake, or with an ice cream based cake as the center of activity. The absence of birthday candles and the blowing out of the candles is somewhat a disappointment to many. Birthday candles poked into a cake may interfere with the frosting or the designs on the cake. Or if the cake is ice cream based, candles may not pierce the solid surface. A separate support for the birthday candles is the subject of this application.

Prior art methods for providing candles associated with a birthday are seen, for example, in U.S. Pat. No. 2,202,509 issued May 28, 1940 to F. J. Addis et al entitled METHOD OF MANUFACTURING CONFECTION CANDLE HOLDERS which describes a method of manufacturing confection candle holders. Each holder has a flat bottom which can support one candle when the candle holder is put on the cake. Each candle must be separately assembled to its holder before the holder is put on the cake. These candle holders are different from the present solution.

In non-patent literature, candle holders exist as can be found at http://gallery.yopriceville.com/Free-Clipart-Pictures/Happy-Birthday-PNG/Birthday_ . . . and http://p30car.com/happy-birthday-candle-for-create-amazing-party-in-your-live/rem . . . . One candle holder accepts one candle and has a spike at its base to poke into a cake. Another candle holder has arms, each of which holds one candle. Neither of these is an artificial cake surface to be filled with candles as described in the present application.

### SUMMARY

The embodiments disclosed herein provide an artificial birthday cake candle holder having a monolithic solid body of predetermined size and shape, simulating a real birthday cake. A top surface of the monolithic body has a plurality of holes with closed bottoms to hold birthday type candles at a predetermined spacing, the holes with closed bottoms extending vertically downward from a plane of a top surface of the body to stabilize the candles to be placed therein. The monolithic body is provided with excess candle holes with closed bottoms to support the needed number of birthday candles used to test the breath strength of the honored guest.

In a first embodiment the body is of solid material construction, while the second and third embodiments are of hollow ceramic construction to avoid weight.

### BRIEF DESCRIPTION OF THE DRAWINGS

FIG. 1A is a pictorial view of a first embodiment for a solid material “Artificial Birthday Cake Candle Holder”;

FIG. 1B is a cross section view of the embodiment of FIG. 1A along line 1B-1B;

FIG. 1C is a cross section view of the embodiment of FIG. 1A along line 1C-1C;

FIG. 2A is a pictorial view of a second embodiment for a hollow “Artificial Birthday Cake Candle Holder”;

FIG. 2B is a cross section view of the embodiment of FIG. 2A along line 2B-2B;

FIG. 2C is a cross section view of the embodiment of FIG. 2A along line 2C-2C;

FIG. 2D is a pictorial view of the hollow “Artificial Birthday Cake Candle Holder” attached to a dish;

FIG. 2E is cross section view of the modified second embodiment of FIG. 2D along line 2E-2E;

FIG. 2F is a cross section view of the modified second embodiment of FIG. 2D along line 2F-2F;

FIG. 3A is a pictorial view of a third embodiment of a hollow “Artificial Birthday Cake Candle Holder” dish;

FIG. 3B is a cross section view of the embodiment of FIG. 3A along line 3B-3B;

FIG. 3C is a cross section view of the embodiment of FIG. 3A along line 3C-3C;

### DETAILED DESCRIPTION

The “Artificial Birthday Cake Candle Holder” is disclosed herein in three embodiments, but they all share this overview. Each embodiment provides support for a plurality of candles supported in one monolithic candle holder used away from a real birthday cake. The artificial birthday cake candle holder functions at birthday celebrations and relates to living achievement. The honored guest blows out all the candles he can with a single breath. The lighting of candles is a time of joyful singing, wishing and breath strength testing as evidence of vigor. The artificial birthday cake candle holder has an expected burn usage time of three minutes. The candle holder can be made of wook in circular shape with candle holes in any pattern. Families with older members use more than a box of birthday candles. A rectangular shaped artificial birthday cake candle holder is ideal in this case with exemplary set of ten rows each with ten holes, making counting easy. The number of holes exceeds the need for the current year's celebration, as it's intended to be reused year after year, or for different birthdays in the same year. The artificial birthday cake candle holder has holes with closed bottoms to insert birthday cake type candles. The holes all share the same elevation since they all begin at the artificial cake's top surface which is a horizontal plane. While identified and described herein as an artificial birthday cake, the artificial cake can be made in other shapes to celebrate other events. The drawings were made with a small number of representative candle holes for simplicity. Alterative embodiments may have larger or smaller numbers of holes.

Drawing Element Numbers for reference in the following description are:

First embodiment of the artificial birthday cake candle holder 10
Second embodiment of the artificial birthday cake candle holder 10′
Third embodiment of the artificial birthday cake candle holder 10″
Body (first embodiment) 12
Top surface 14

### Side 16

Long line end 18

### Holes 20

Hole bottom 22
Body (second embodiment) 24
Extending dish 26

### Cavity 28

Body (third embodiment) 30

### Description of a First Embodiment

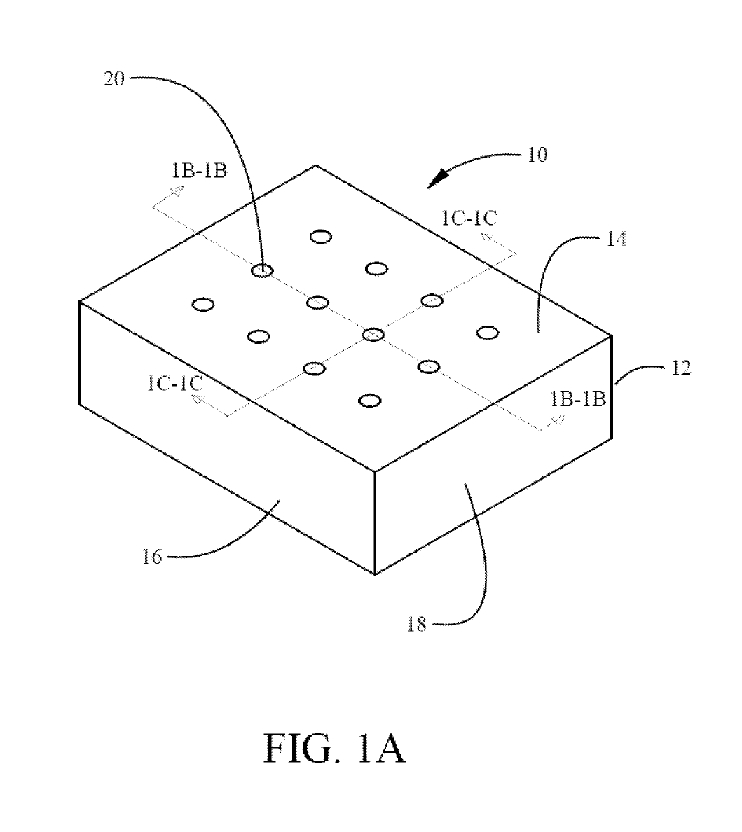

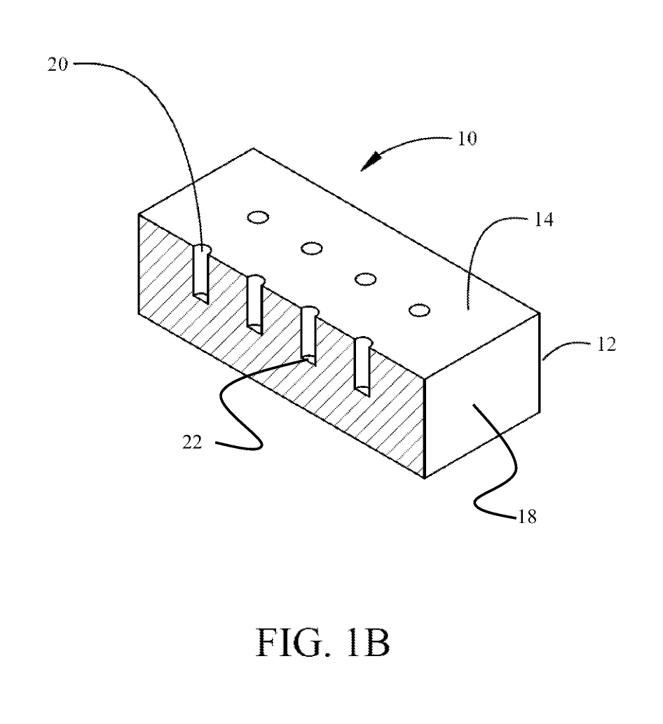

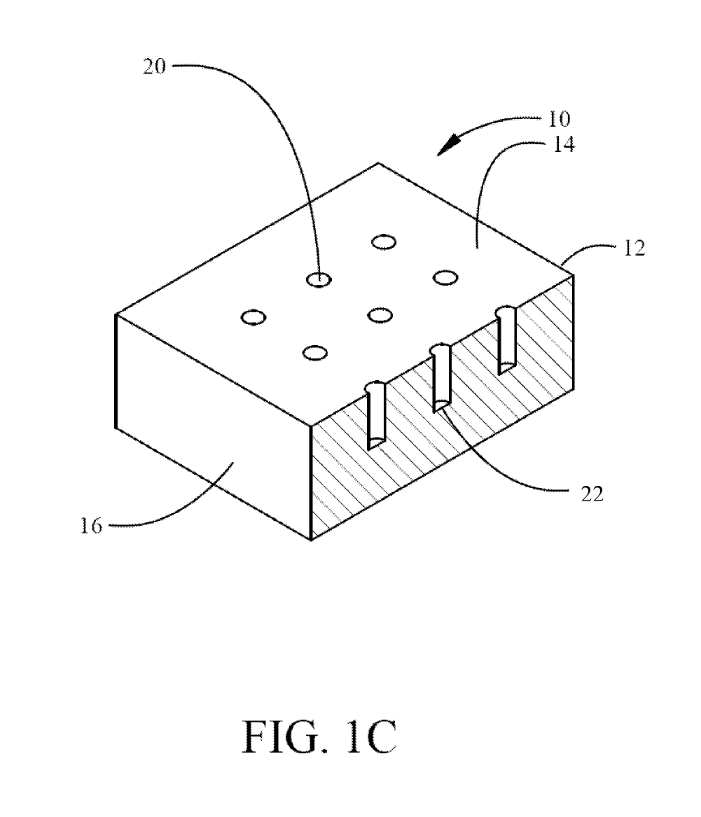

Referring to the drawings, a first embodiment is shown in FIGS. 1A, 1B and 1C. FIG. 1A shows the artificial birthday cake candle holder 10 having a body 12 made of solid material. A top surface 14, side 16, and long line end 18 of the body 12 are identified for reference and drawing views. A plurality of holes 20 are provided in the body 12. The spacing of the holes 20 is best kept at one inch or greater to prevent candle melting, and yet may be adjusted to fit any size constraints desired in alternative embodiments. The example twelve candle holder shown in FIG. 1A is made of wood. The size is four by five inches and one and a half inches thick. Each hole 20 has a closed bottom 22 (best seen in FIGS. 1B and 1C) and, for the embodiment shown, is one quarter of an inch in diameter and three quarters of an inch deep measured from the top surface 14. The solid structure of the embodiment is shown in FIG. 1B which shows a cross sectional view parallel to the side 16 of FIG. 1A. The section view passes through the long line of four holes 20 demonstrating the closed bottoms 22. Similarly FIG. 1C shows a cross sectional view parallel to the long line end 18 of FIG. 1A. The section view passes through three holes 20 again demonstrating the closed bottoms 22.

When working with wood the shape of the piece can change with age and water exposure. The project is more satisfactory if it does not rock when placed on a table. If it rocks, one realizes it would not rock when upside down. Here is a method to predict which side should be made the top surface 14. Before making any holes, observe the end grain of the board. The end grain generally arcs upward or downward. Place the board flat on a table such that the end grain arcs upward as the horns of an animal. In this position the holes should be made from the top surface 14. In time when this board begins to bend, the end grain line will flatten out—leaving less curve. This causes the top surface 14 of the board to become rounded (not good for a bottom) and the bottom of the board to become cupped (making a good base—as the runners of a sled). Finish this project by giving it a water proof coating such as boiled linseed oil on all six sides.

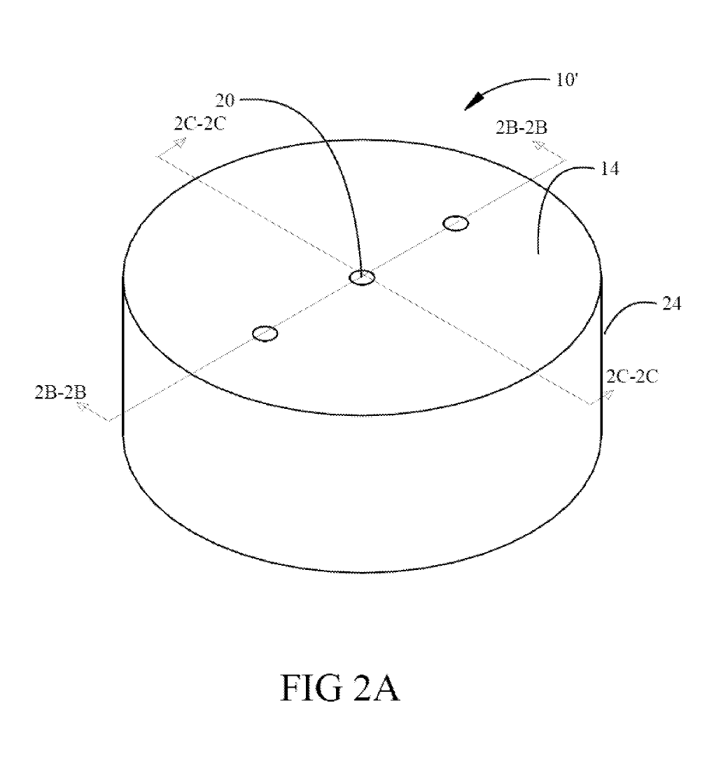

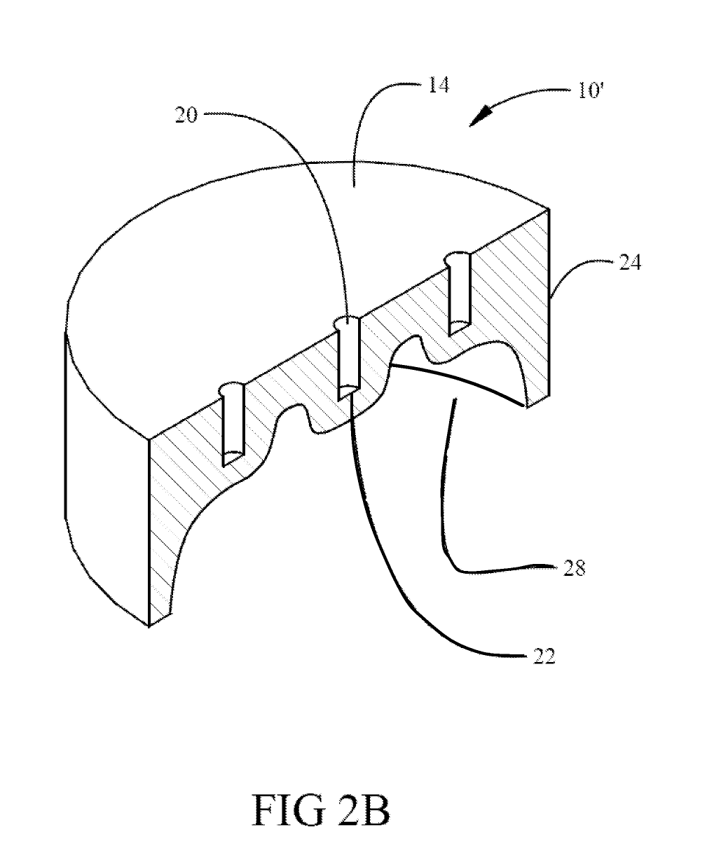

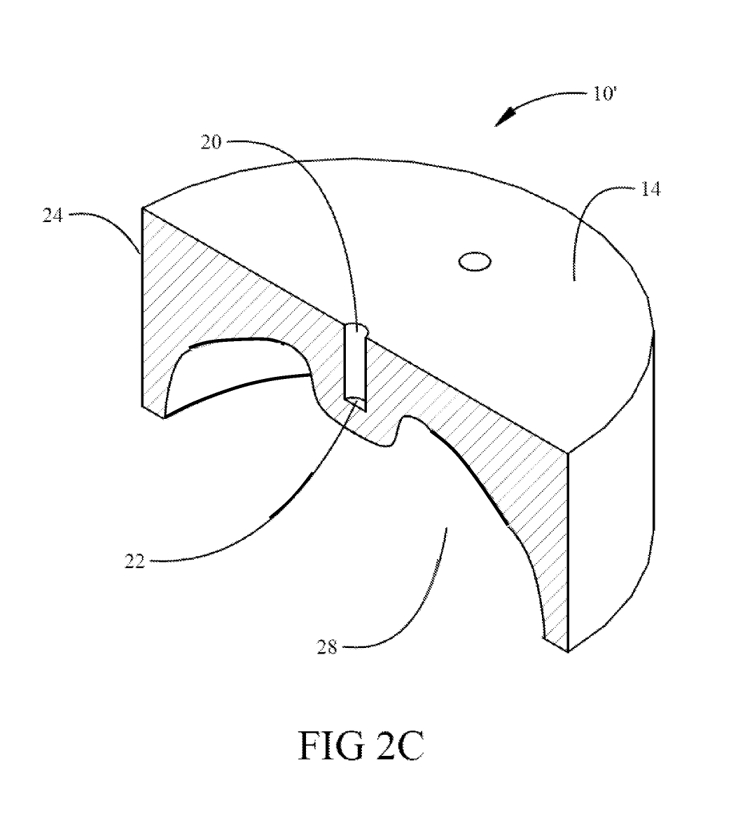

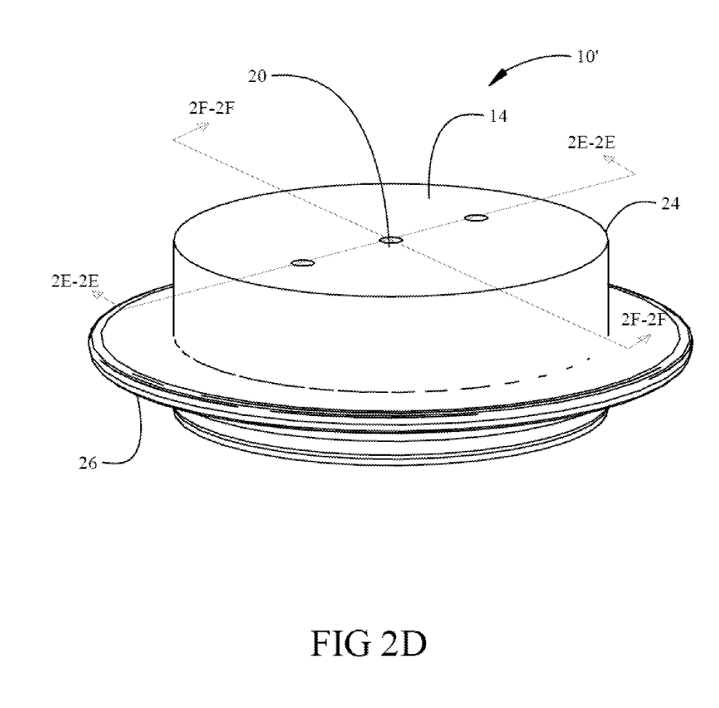

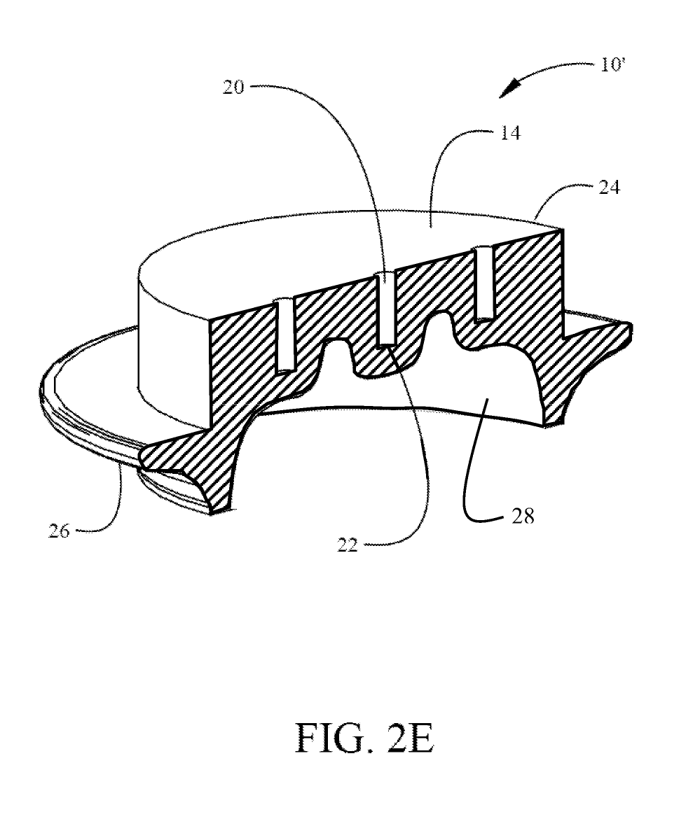

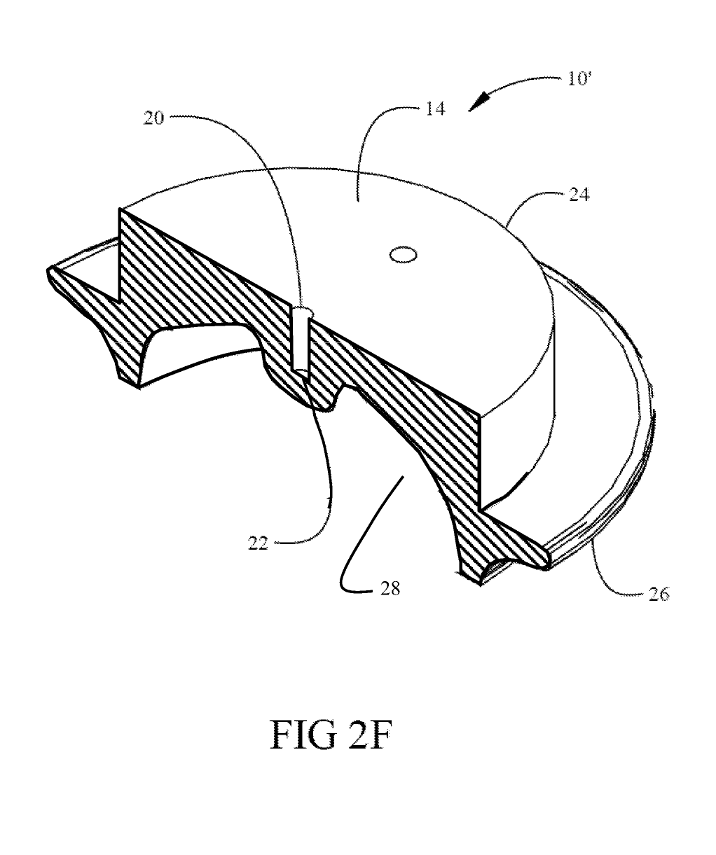

This embodiment can be made from other material. A cake shape can be made of solids such as ceramics, clay, plaster, or plastic. A round solid plaster cake can be formed directly onto an existing dish to look like FIG. 2D. But it would be solid material.

### Operation of the First Embodiment

The candle holder is designed with a predetermined number of holes for candles greater than one is expected to use often. The number of candles desired are placed in holes to make complete rows of candles. Counting individual candles is therefore eliminated when nearing completion. When ready to light the candles, be sure to light the candles in the middle first since it may be difficult to light the candles in the middle if the edge candles are burning. If available use some means of holding the lighting flame on an extension rod. Also, if help is available; request help to save time. Once lit, proceed with the Happy Birthday Song, followed by wish making by the guest of honor, and then the triumphant blowing out of the candles before they burn shorter than a half inch. Afterward save the candleholder for the next use.

### Advantages of the First Embodiment

Fancy frosting or frozen birthday cakes can now be enjoyed in the presence of burning candles. The natural solid wood candle holder is very robust. It can withstand rough handling and dropping.

### Description of a Second Embodiment

A second embodiment is shown in FIGS. 2A, 2B, 2C, 2D, 2E, and 2F which provides a hollow ceramic structure of the cake body to make it as light weight as possible. FIGS. 2A and 2D show the hollow artificial birthday cake candle holder 10′ with top surface 14. The spacing of the holes 20 is best kept at one inch apart or greater, yet adjusted to fit within any size constraints desired.

The artificial birthday cake candle holders shown in FIGS. 2A and 2D are adapted to hold three candles and have a body 24 made of slip material such as ceramics. For the exemplary embodiments, each circular cake is four inches in diameter. The cake in FIG. 2D has the body 24 with an extending dish 26 which gives the appearance of a cake sitting on a dish. For an exemplary embodiment the dish is a seven inches in diameter. In the exemplary embodiment, each hole 20 is one quarter inch diameter and three quarters of an inch deep. FIGS. 2B and 2E show a first cross sectional view of FIGS. 2A and 2D respectively. This cut passes through the long line of three holes 20. Similarly FIGS. 2C and 2F show a second cross sectional view of FIGS. 2A and 2D respectively. This cut passes through only one hole 20. Both section views demonstrate the closed bottom 22 of the holes 20. While only one row of holes 20 is shown for these embodiments for simplicity in drawing presentation, as previously described additional rows and numbers of holes may be employed.

These hollow ceramic bodies 24 are made by pouring a clay-water mixture called slip material into a mold. After a period of time the clay solidifies on the inner surface of the mold. Before all the slip material is solid, the liquid portion is poured out leaving a hollow cavity 28 in the ceramic body 24. The hollow body is then fully dried and placed in a kiln. After firing in the kiln, glazing compounds are painted on the bodies and placed in the kiln again. Celebratory words and symbols may also be added to the glazed bodies.

### Operation of the Second Embodiment

Operation the artificial birthday cake candle holder of the second embodiment is substantially identical to operation of the first embodiment.

### Advantages of the Second Embodiment

Fancy frosting or frozen birthday cake can now be enjoyed in the presence of burning candles. The ceramic cake is elegant looking and may be molded with varying design features to simulate decorative frosting which may then be painted or included in the glazing for additional realism.

### Description of a Third Embodiment

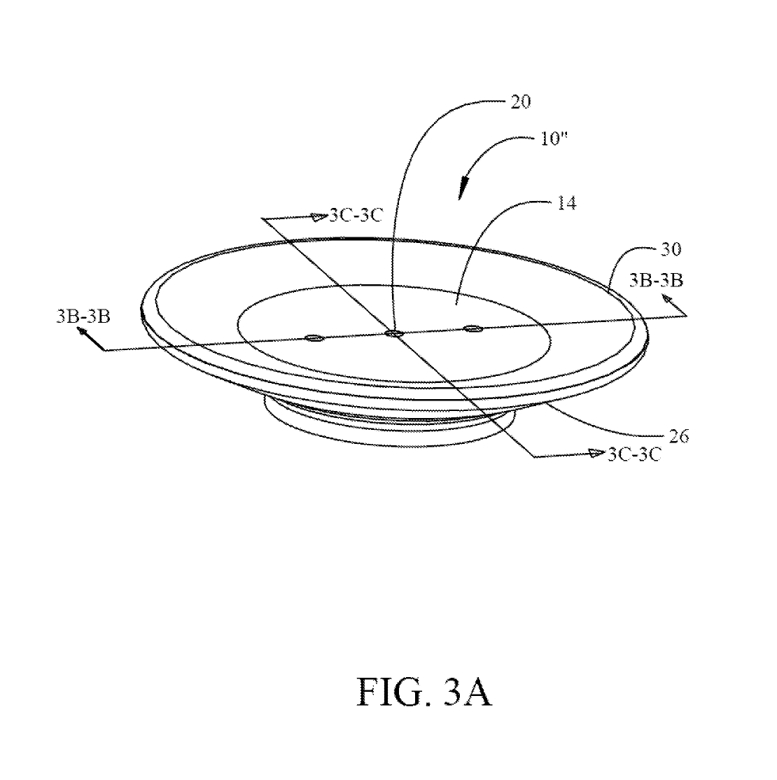

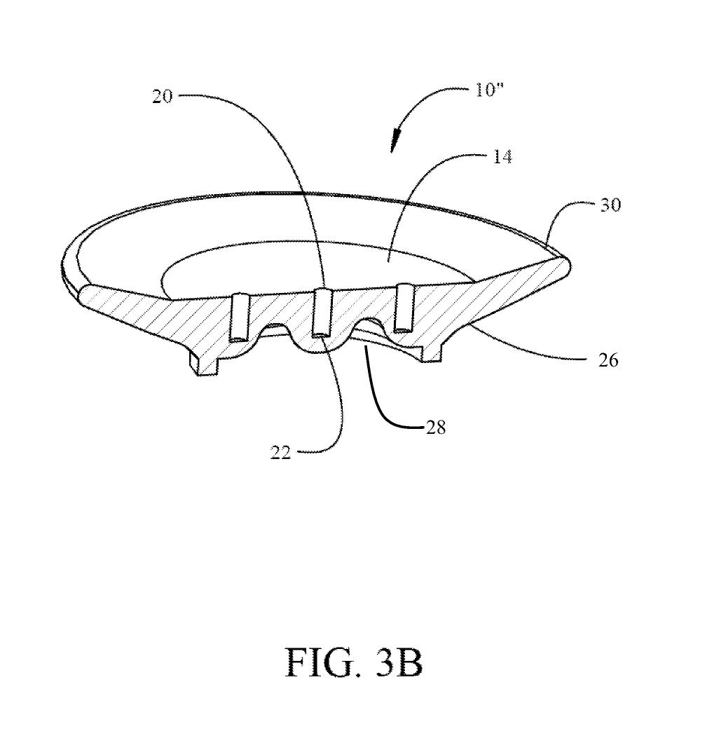

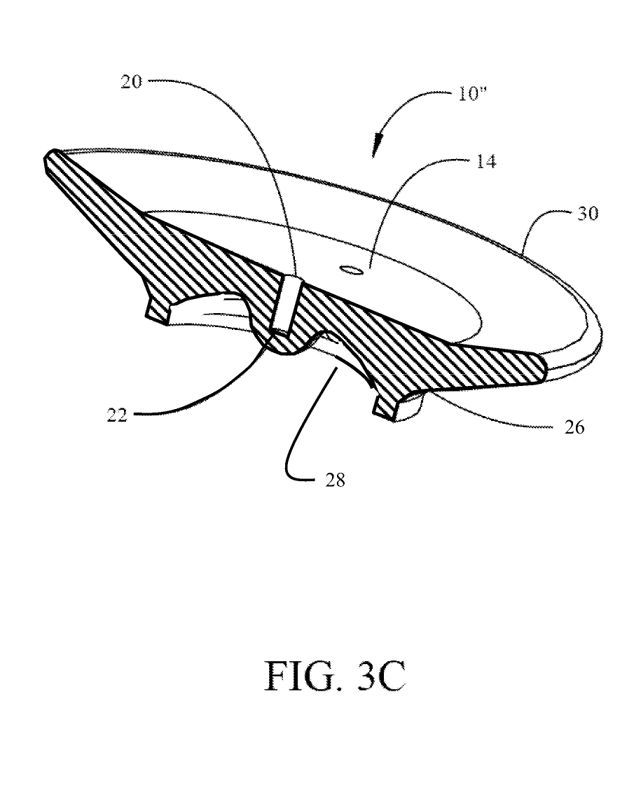

The concept of birthday candles burning on a cake is approximated by a thick dish with birthday candles burning on the circular plane of the dish as shown in the third embodiment of FIGS. 3A, 3B, and 3C. FIG. 3A shows a hollow artificial birthday cake candle holder 10″ which is substantially solely a dish having a top surface 14, without a visible cake. The spacing of the holes 20 are best kept at one inch apart or greater, yet adjusted to fit within any size constraints desired. While only one row of holes 20 is shown for these embodiments, as previously described additional rows and numbers of holes may be employed.

The three candle holder shown in FIG. 3A is made of slip material such as ceramics. The structure of the embodiment provides a body 30 which incorporates the dish 26, which for the exemplary embodiment is seven inches in diameter and one and a half inches thick. A top surface 14 of the body is substantially coplanar with a top surface of the dish 26. At the top surface 14 each hole 20 is a quarter of an inch diameter and three quarters of an inch deep. The structure, as in the second embodiment, provides a hollow cavity 28 as seen in FIG. 3B. This cross section view passes through the long line of three holes 20. Similarly FIG. 3C shows a second cross section view which passes through only one hole 20. Both section views show the closed bottom 22 of the holes 20.

The hollow ceramic body 30 is made by pouring a clay-water mixture called slip material into a mold. After a period of time the clay solidifies on the inner surface of the mold. Before all the slip material is solid, the liquid portion is poured out leaving a hollow cavity 28 in the ceramic body. The hollow body 30 is the fully dried and placed in a kiln. Afterward glazing compounds are painted on these bodies and placed in the kiln again. Celebratory words and symbols are also added to the glazed bodies.

### Operation of the Third Embodiment

Operation the artificial birthday cake candle holder of the third embodiment is substantially identical to operation of the first embodiment.

### Advantages of the Third Embodiment

Fancy frosting or frozen birthday cake can now be enjoyed in the presence of burning candles. The ceramic dish is minimalistic and occupies little storage space.

### Conclusion

The three embodiments all yield similar results. The real birthday cake will not be affected by the candle burning. Younger families will likely use a round shape because, their candle usage will more closely fit the number of holes provided. Once used, the separation of the real cake and candles will be appreciated.

### General Advantages of All Embodiments of the Invention

An “Artificial Birthday Cake Candle Holder” has some mental connection to a real cake when the candles are lit and provides the candle blowing wish feature of a birthday party, even when no cake is available or the cake is frozen. Some people are reluctant to eat a cake when someone else blew on it. The “Artificial Birthday Cake Candle Holder” can become a tradition even when a real birthday cake is available. It becomes identified as the place to burn the candles, rather than on the real cake.

Restaurants can participate more fully in birthday celebrations using the invention. Typically restaurants use a cupcake with one candle, rather than a whole cake for the few people at a table. It never seems a triumph to blowout one candle to represent all the years of life someone has had. Blowing out the candles is a gesture of ability to have succeeded. It is a time to wish for the future.

It is not hard to imagine this excitement carrying over to other endeavors in which an alternative embodiment of the invention may be employed such as:

A child passing seventh grade could show his confidence by blowing out seven candles on an artificial book shaped cake.

A child's sports success could be celebrated in the number of candles on a sports shaped artificial cake.

A couple's wedding anniversary with the number of years as candles on a wedding bell shaped artificial cake.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. An artificial birthday cake candle holder comprising;
a monolithic body of predetermined size and shape, simulating a real birthday cake,
a top surface of said monolithic body having a plurality of holes with closed bottoms to hold birthday type candles at a predetermined spacing,
said holes with closed bottoms extending vertically downward from a plane of said top surface to stabilize said candles to be placed therein, said monolithic solid body having a predetermined number of candle holes with closed bottoms to exceed the needed number of birthday candles used to test the breath strength of the honored guest.

2. The artificial birthday cake candle holder as defined in claim 1 wherein the monolithic body is solid.

3. The artificial birthday cake candle holder as defined in claim 2 wherein the monolithic body is made of a solid selected from the set of wood, ceramic, clay, plaster, or plastic.

4. The artificial birthday cake candle holder as defined in claim 1 wherein the monolithic body is ceramic, said ceramic providing a hollow cavity in the body.

5. The artificial birthday cake candle holder as defined in claim 4 wherein the monolithic body incorporates an extending dish.

6. The artificial birthday cake candle holder as defined in claim 5 wherein the extending dish is substantially flush with the top surface of the body.

7. An artificial birthday cake candle holder comprising;
a monolithic hollow ceramic body of predetermined size and shape, simulating a real birthday cake alone or a real cake attached to a dish,
a top surface of said monolithic hollow ceramic body having a plurality of holes with closed bottoms to hold birthday type candles at a predetermined spacing, said holes with closed bottoms extending vertically downward from a plane of said top surface to stabilize said candles to be placed therein, said monolithic hollow ceramic body having excess candle holes with closed bottoms to support the needed number of birthday candles used to test the breath strength of the honored guest.

8. An “artificial birthday cake candle holder” comprising;
a monolithic hollow base ceramic dish of predetermined size and shape simulating only a top surface plane of a real cake,
a top surface of said dish having a plurality of holes with closed bottoms to hold birthday type candles at a predetermined spacing,
said holes with closed bottoms extending vertically downward from said plane of said top surface to stabilize said candles to be placed there in, said monolithic hollow base ceramic dish approximating a birthday cake on a dish but without the cake only the dish having excess candle holes with closed bottoms to support the needed number of birthday candles used to test the breath strength of the honored guest.
